(19) United States
(12) Patent Application Publication
(10) Pub. No.: US 2019/0109437 A1
(43) Pub. Date: Apr. 11, 2019

(54) ION AIR SUPPLY MODULE NEEDLE NET LAYOUT METHOD AND ION AIR SUPPLY MODULE

(71) Applicants: QINGDAO HAIER SMART TECHNOLOGY R & D CO., LTD, Dingdao, Shandong Province (CN); HARBIN INSTITUTE OF TECHNOLOGY, Harbin, Heilongjiang Province (CN)

(72) Inventors: Jingfeng TANG, QINGDAO, SHANDONG PROVINCE (CN); Liqiu WEI, QINGDAO, SHANDONG PROVINCE (CN); Daren YU, QINGDAO, SHANDONG PROVINCE (CN); Yongtao WANG, QINGDAO, SHANDONG PROVINCE (CN); Lichen ZHANG, QINGDAO, SHANDONG PROVINCE (CN); Jian LI, QINGDAO, SHANDONG PROVINCE (CN); Jingjing WANG, QINGDAO, SHANDONG PROVINCE (CN); Zhuang MA, QINGDAO, SHANDONG PROVINCE (CN); Linqiang TANG, QINGDAO, SHANDONG PROVINCE (CN)

(73) Assignees: QINGDAO HAIER SMART TECHNOLOGY R & D CO., LTD, Dingdao, Shandong Province (CN); HARBIN INSTITUTE OF TECHNOLOGY, Harbin, Heilongjiang Province (CN)

(21) Appl. No.: 16/087,433

(22) PCT Filed: May 31, 2016
(86) PCT No.: PCT/CN2016/083993

§ 371 Date: Sep. 21, 2018

(30) Foreign Application Priority Data
Mar. 28, 2016 (CN) 201610180852.2

(51) Int. Cl. H01T 19/04; H01T 23/00; B03C 3/68; B03C 3/12

(52) U.S. Cl. CPC H01T 19/04; B03C 3/12; B03C 3/68; H01T 23/00

(57) ABSTRACT

Provided are an ion air supply module needle net layout method and an ion air supply module. The layout method comprises: step 1, a wind speed test: adjusting a distance between a single discharge needle and a metal net, so that an ion wind speed at the wind speed central point position of the metal net is at the maximum, and measuring a distance value L between a tip of the discharge needle and the metal net; step 2, a projection radius measurement: measuring a wind speed Vr deviating from the wind speed central point position, and when Vr=aVmax, measuring that the distance between a wind speed measurement point and a wind speed central point is r; and step 3, a needle net layout: setting the distance between the tip of the discharge needle and the metal net to be within the range of (0.7-1.3)L, with the distance between tips of two adjacent discharge needles being within the range of (0.7-1.3)r. The present invention improves the air supply speed, air supply volume and air supply efficiency of an ion air supply module.

### TECHNICAL FIELD

The invention relates to the technical field of ionic wind, and in particular to a needle-to-mesh electrode configuration method of ionic wind generating module and an ionic wind generating module.

### BACKGROUND

Relying on the advantages of being simple in structure, noise-free and capable of being used in air purifier, the ionic wind created by corona discharge becomes an attractive study area all across the world with great market potential and prospects. The ionic wind is the creation of movement of air by means of a corona discharge: high voltage is applied on emitter needle electrode to create an electric field in the vicinity of the tip of the emitter needle which is strong enough to ionize gas molecules in the dielectric surrounding while out of the area the electric field is comparatively weak where ionization barely occurs. Charged particles are induced to move by the strong electric field, and in the process, they will undergo collisions with neutral particles and give them momentum to enable them to flow together, and thereby generating the ionic wind. Practically in the prior art, as the detailed number of needle electrons and the position of a metallic mesh are being determined, the applied voltage is raised to produce higher ionic wind velocity. However, if the applied voltage is raised too much, the discharge will change into a spark and further cause a voltage drop between the emitter electrode and the collector electrode, which results in extremely weak ionic wind or no ionic wind.

Accordingly, the ionic wind velocity and intensity produced by the traditional ionic wind generator with a needle-to-mesh configuration, and its efficiency are far from satisfactory.

### TECHNICAL SOLUTION

Provided by the present invention are a needle-to-mesh electrode configuration method of ionic wind generating module and an ionic wind generating module in order to improve the air velocity, intensity and efficiency of the traditional ionic wind generating module.

A needle-to-mesh electrode configuration method of ionic wind generating module, wherein the ionic wind generating module comprising a metallic mesh and a plurality of emitter needles in an array disposed at one side of the metallic mesh, comprises:

Step 1: ionic wind velocity test, which comprising: adjusting the distance between a single emitter needle and the metallic mesh to enable the ionic wind velocity at a corresponding air velocity central point on the metallic mesh to reach the maximum value under the premise that the voltage between the emitter needle and the metallic mesh is unchanged; measuring the adjusted distance L between the one emitter needle and the metallic mesh as the ionic wind velocity at the corresponding air velocity central point maintaining at its maximum value Vₘₐₓ, wherein the corresponding velocity central point is the projective area of the tip of the emitter needle on the metallic mesh;

Step 2: measurement of the radius of the projection area, which comprising: monitoring the ionic wind velocity Vᵣ at a velocity measuring point deviating from the velocity central point until Vᵣ=a Vₘₐₓ; measuring the distance r between the velocity measuring point and the velocity central point as Vᵣ=a Vₘₐₓ, wherein a is a constant in a range from 0.3 to 0.7;

Step 3: needle-to-mesh configuration, which comprising: setting the distance between the tips of the emitter needles and the metallic mesh in the range of 0.7 L to 1.3 L, and setting the distance between tips of any two adjacent emitter needles in the range of 0.7 r to 1.3 r.

The invention also provides an ionic wind generating module comprising:

a flow duct;

a plurality of emitter needles;

a metallic mesh;

a needle support;

wherein the metallic mesh and the needle support being arranged within the flow duct and the emitter needles being disposed on the needle support in an array at one side of the metallic mesh;

wherein the distance between the tips of the emitter needles and the metallic mesh is in the range of 0.7 L to 1.3 L, and the distance between tips of any two adjacent emitter needles is in the range of 0.7 r to 1.3 r; L is a measured distance between one of the emitter needles and the metallic mesh which is being determined at the moment when the ionic wind velocity at a corresponding air velocity central point on the metallic mesh reaching its maximum value Vₘₐₓ in the process of adjusting the distance between the one emitter needle and the metallic mesh under the premise of the unchanged voltage between the emitter needle and the metallic mesh, and the corresponding air velocity central point is the projective area of the tip of the one emitter needle; and r is a measured distance between a velocity measuring point and the velocity central point which is being determined at the moment when the ionic wind velocity Vᵣ at a velocity measuring point equal to aVₘₐₓ, wherein the velocity measuring point deviating from the velocity central point and a is a constant in a range from 0.3 to 0.7.

The ionic wind generating module and the needle-to-mesh electrode configuration method provided by the present invention discloses an optimum positional design of the emitter needles and the metallic mesh, in which the distance between the emitter needles and the metallic mesh could ensure a comparatively large ionic wind velocity and the array of the emitter needles could be matched with the size of the metallic mesh. Accordingly, the number of the emitter needles could be determined based on the size of the metallic mesh to create the ionic wind with high capacity and uniform distribution, and thereby the air velocity, intensity and efficiency of the ionic wind generating module are improved. At the same time, under the premise of the same ionic wind volume, the number of needles can be effectively reduced, so that the power consumption is minimized.

### BRIEF DESCRIPTION OF THE DRAWINGS

FIG. 1 is a schematic structural view 1 of an embodiment of an ionic wind generating module according to the present invention;

FIG. 2 is a schematic structural view 2 of an embodiment of an ionic wind generating module according to the present invention;

FIG. 3 is a cross-sectional view of an embodiment of an ionic wind generating module according to the present invention.

### DETAILED DESCRIPTION

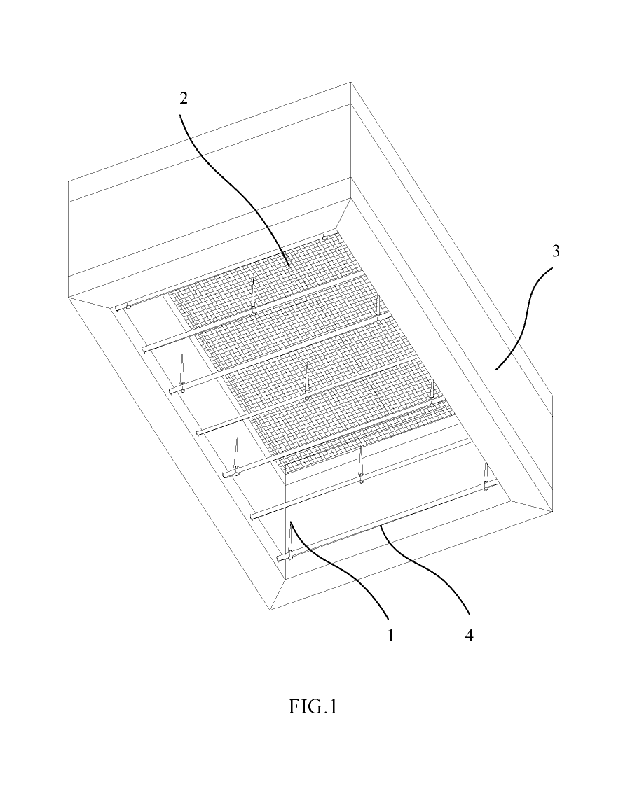

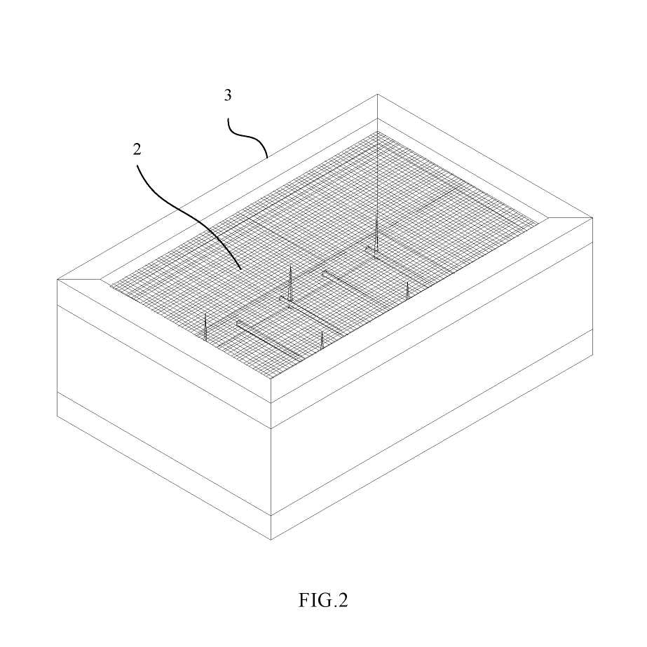

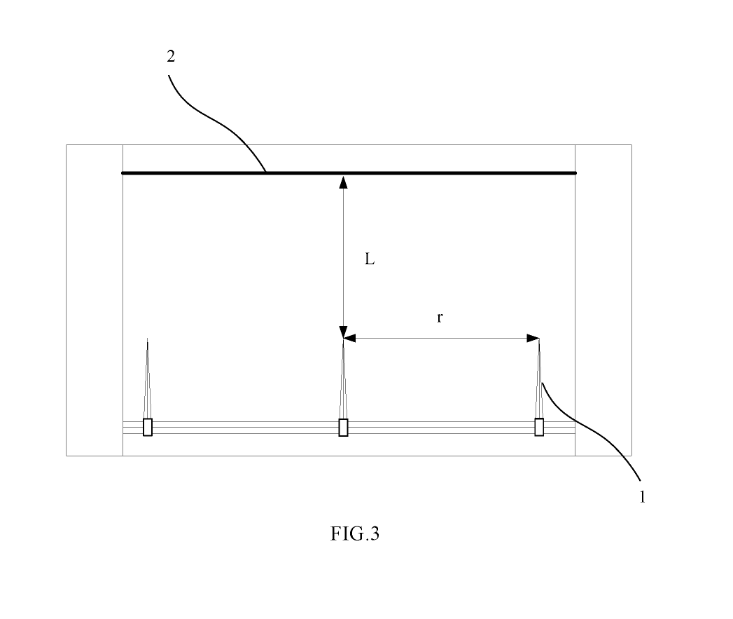

As shown in FIG. 1 to FIG. 3, an ionic wind generating module provided by the present invention comprises a plurality of emitter needles 1, a metallic mesh 2, a flow duct 3 and a needle support 4, wherein the emitter needle 1 arranged in an array are disposed at one side of the metallic mesh 2, and the metallic mesh 2 and the needle support 4 are arranged within the flow duct 3. The distance between each of the tips of the emitter needles 1 and the metallic mesh 2 is in the range of 0.7 L to 1.3 L, and the distance between any two tips of adjacent emitter needles is in the range of 0.7 to 1.3 r, wherein L is the distance between one of the emitter needles 1 and the metallic mesh 2 while the ionic wind velocity at an air velocity central point of the metallic mesh 2 reaches the maximum value Vₘₐₓ, and the air velocity central point is the corresponding projective point of the tip of the one emitter needle 1 on the metallic mesh 2; r is the distance between an air velocity measuring point, which is deviated from the air velocity central point, and the air velocity central point, whereinVᵣ is the ionic wind velocity at the velocity measuring point and Vᵣ=a Vₘₐₓ, wherein a is a constant in a range from 0.3 to 0.7.

Further, the present invention discloses a needle-to-mesh electrode configuration method to arrange the emitter needle 1 and the metallic mesh 2 in the ionic wind generating module, which comprises the following steps:

Step 1: ionic wind velocity test, which comprises: adjusting the distance between a single emitter needle 1 and the metallic mesh 2 to enable the ionic wind velocity at the corresponding air velocity central point to reach its maximum value under the premise that the voltage between the emitter needles 1 and the metallic mesh 2 is unchanged; and then measuring the adjusted distance L between the emitter needle 1 and the metallic mesh 2 as the ionic wind velocity at the corresponding air velocity central point maintaining at its maximum value, wherein the velocity central point is the corresponding projective area of the tip of the one emitter needle 1 on the metallic mesh 2. To be specific, under the premise of the unchanged voltage in the gap between the emitter needles 1 and the metallic mesh 2, during the process to accurately adjust the distance between one of the emitter needles 1 and the metallic mesh 2, the ionic wind velocity at the corresponding velocity central point could be monitored by an anemometer until the moment as it reaches the maximum ionic wind velocity, and then the adjusted distance is the optimum distance between the emitter needle 1 and the metallic mesh 2 which could be determined by measuring to ensure the ionic wind velocity produced by the one single emitter needle be at its maximum. The distances L and r further might depend on parameters as the materials of the emitter needle 1, the radius of curvature of the needle tips and the length of the emitter needle 1. That means if the type of the emitter needle 1 is different, the distances L and r may vary.

Step 2: measurement of the radius of the projection area, which comprises: monitoring the ionic wind velocity Vᵣ at a point deviating from the velocity central point until Vᵣ=a Vₘₐₓ, and measuring the distance r between the velocity measuring point and the velocity central point, wherein a is a constant in a range from 0.3 to 0.7. To be specific, on one hand, the ionic wind velocity will become weaker due to the fact that the ionic wind produced by either of the adjacent emitter needles might be counteracted by the other if adjacent emitter needles are arranged too close, and on the other hand, the ionic wind also could be weakened or unevenly distributed if the emitter needles 1 are arranged too loose. Therefore, to avoid such two circumstances, an effective ionic wind velocity area on the metallic mesh 2 could be determined by measuring the adjusted distance between the velocity measuring point and the velocity central point as the measured ionic wind velocity Vᵣ at a point deviating from the velocity central point reaches a Vₘₐₓ, namely Vᵣ =a Vₘₐₓ.

Step 3: needle-to-mesh configuration, which comprises: setting the distance between the tips of the emitter needles 1 and the metallic mesh 2 in the range of 0.7 L to 1.3 L, and setting the distance between tips of any two adjacent emitter needles 1 in the range of 0.7 to 1.3 r. To be specific, the needle-to-mesh configuration could reach an optimum state as both of the distance between the emitter needles 1 and the metallic mesh 2 and the distance between tips of any two adjacent emitter needles 1 being set in the ideal ranges respectively. Further, the distance between the tips of the emitter needles 1 and the metallic mesh 2 in the range of 0.7 L to 1.3 L could ensure the maximum ionic wind volume produced between a single emitter needle and the metallic mesh. The distance between tips of any two adjacent emitter needles 1 in the range of 0.7 to 1.3 r could avoid the ionic wind produced by either of adjacent emitter needles being counteracted by the other, and could further ensure that part of the effective ionic wind velocity areas are overlapped to achieve an projection effect as produced by a shadowless lamp, so that the ionic wind could be distributed in a more uniform state. Preferably, the emitter needles are parallel with each other and the overall configuration of three adjacent emitter needles are in a layout of the shape of an equilateral triangle, which could enhance the uniformity of ionic wind distribution. The tips of the emitter needles are all arranged in one plane, such that the plane where the tips of the emitter needles in is parallel with the plane where the metallic mesh 2 on and the emitter needles are perpendicular to the plane where the metallic mesh 2 on, so as to ensure the same intensity of the ionic wind produced by every single of the emitter needles. Preferably, the distance between the tips of the emitter needles 1 and the metallic mesh 2 is set as L, and the distance between the tips of two adjacent emitter needles 1 is set as r.

The ionic wind generating module and the needle-to-mesh electrode configuration method provided by the present invention discloses an optimum positional design of the emitter needle and the metallic mesh, in which the distance between the emitter needles and the metallic mesh could ensure a comparatively large ionic wind velocity and the array of the emitter needles could be matched with the size of the metallic mesh. Accordingly, the number of the emitter needles could be determined based on the size of the metallic mesh to create the ionic wind with high capacity and uniform distribution, and thereby improving the air velocity, intensity and efficiency of the ionic wind generating module.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims. This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A needle-to-mesh electrode configuration method of ionic wind generating module, wherein the ionic wind generating module comprising a metallic mesh and a plurality of emitter needles in an array disposed at one side of the metallic mesh, comprises:
Step 1: ionic wind velocity test, which comprising: adjusting the distance between a single emitter needle and the metallic mesh to enable the ionic wind velocity at a corresponding air velocity central point on the metallic mesh to reach the maximum value under the premise that the voltage between the emitter needle and the metallic mesh is unchanged; measuring the adjusted distance L between the emitter needle and the metallic mesh as the ionic wind velocity at the corresponding air velocity central point maintaining at its maximum value Vₘₐₓ, wherein the corresponding velocity central point is the projective area of the tip of the one emitter needle on the metallic mesh;
Step2: measurement of the radius of the projection area, which comprising: monitoring the ionic wind velocity Vᵣ at a velocity measuring point deviating from the velocity central point until Vᵣ=a Vₘₐₓ; measuring the distance r between the velocity measuring point and the velocity central point as Vᵣ=a Vₘₐₓ, wherein a is a constant in a range from 0.3 to 0.7;
Step3: needle-to-mesh configuration, which comprising: setting the distance between the tip of the emitter needle and the metallic mesh in the range of 0.7 L to 1.3 L, and setting the distance between tips of any two adjacent emitter needles in the range of 0.7 to 1.3 r.

2. The needle-to-mesh electrode configuration method of ionic wind generating module according to the claim 1, wherein in Step 3, the needle-to-mesh configuration further comprises: enabling the emitter needles to be parallel with each other, and enabling any three adjacent emitter needles to be configured in a layout of an equilateral triangle.

3. The needle-to-mesh electrode configuration method of ionic wind generating module according to the claim 1, wherein in Step 3, the needle-to-mesh configuration further comprises: enabling tips of the emitter needles to be arranged in one plane.

4. The needle-to-mesh electrode configuration method of ionic wind generating module according to the claim 3, wherein in Step 3, the needle-to-mesh configuration further comprises: enabling the plane where the metallic mesh on to be parallel with the plane where the tips of the emitter needles in.

5. The needle-to-mesh electrode configuration method of ionic wind generating module according to the claim 1, wherein in Step 3, the needle-to-mesh configuration further comprises: enabling the emitter needles to be perpendicular to the plane where the metallic mesh on.

6. The needle-to-mesh electrode configuration method of ionic wind generating module according to the claim 1, wherein in Step 3, the needle-to-mesh configuration further comprises: setting the distance between the tips of the emitter needles and the metallic mesh as L, and setting the distance between tips of any two adjacent emitter needles as r.

7. A ionic wind generating module comprising:
a flow duct;
a plurality of emitter needles;
a metallic mesh;
a needle support;
wherein the metallic mesh and the needle support being arranged within the flow duct, the plurality of the emitter needles being disposed on the needle support in an array at one side of the metallic mesh;
wherein the tip of the emitter needles and metallic mesh is in the range of 0.7 L to 1.3 L, and the distance between tips of any two adjacent emitter needles in the range of 0.7 to 1.3 r;
wherein L is a measured distance between one of the emitter needles and the metallic mesh which is being determined at the moment when the ionic wind velocity at a corresponding air velocity central point on the metallic mesh reaching its maximum value Vₘₐₓ in the process of adjusting the distance between the one emitter needle and the metallic mesh under the premise of the unchanged voltage between the emitter needle and the metallic mesh, and the corresponding air velocity central point is the projective area of the tip of the one emitter needle on the metallic mesh; and r is a measured distance between a velocity measuring point and the velocity central point which is being determined at the moment when the ionic wind velocity Vᵣ at a velocity measuring point reaches to aVₘₐₓ, wherein the velocity measuring point deviating from the velocity central point and a is a constant in a range from 0.3 to 0.7.

8. The ionic wind generating module according to claim 7, wherein the emitter needles are parallel with each other and any three adjacent emitter needles are configured in a layout of an equilateral triangle.

9. The ionic wind generating module according to claim 7, wherein tips of the emitter needles are arranged in one plane.

10. The ionic wind generating module according to claim 9, wherein the plane where the metallic mesh on is parallel with the plane where the tips of the emitter needles in and the emitter needles are perpendicular to the plane where the metallic mesh on.
